(19) United States
(12) Patent Application Publication
(10) Pub. No.: US 2011/0302277 A1
(43) Pub. Date: Dec. 8, 2011

(54) METHODS AND APPARATUS FOR WEB-BASED MIGRATION OF DATA IN A MULTI-TENANT DATABASE SYSTEM

(75) Inventor: Gary Baker, San Francisco, CA (US)

(73) Assignee: SALESFORCE.COM, INC., San Francisco, CA (US)

(21) Appl. No.: 12/984,232

(22) Filed: Jan. 4, 2011

Related U.S. Application Data
(60) Provisional application No. 61/352,278, filed on Jun. 7, 2010.

(51) Int. Cl. G06F 15/16

(52) U.S. Cl. 709/219

(57) ABSTRACT

A computer-implemented system and method includes migrating a database from one multi-tenant database to a second multi-tenant database over a network using a Web protocol such as secure hypertext transfer protocol (HTTPS). The transferred data records may be sent as serializable Java objects in response to a migration request produced by one of the multi-tenant databases.

### CROSS-REFERENCE TO RELATED APPLICATIONS

This application claims the benefit of U.S. provisional patent application Ser. No. 61/352,278, filed Jun. 7, 2010, the entire contents of which are incorporated by reference herein.

### TECHNICAL FIELD

Embodiments of the subject matter described herein relate generally to data processing systems and processes, such as systems and processes that use a common network-based platform to support applications executing on behalf of multiple tenants. More particularly, embodiments of the subject matter described herein relate to the migration of data between databases in a multi-tenant database system.

### BACKGROUND

Modern software development has, to a large extent, evolved away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

A customer relationship management (CRM) system is one example of an application that is suitable for deployment as a cloud-based service. A business, company, or entity using such a CRM system might be concerned about access to the CRM data maintained by the CRM system, even by users who have proper authentication credentials for the CRM system. It is often desirable to migrate (i.e., transfer) data from one physical or logical database to another database, e.g., to accommodate server moves, to improve load balancing, or the like.

Currently known systems for migrating data are unsatisfactory in a number of respects. For example, standard database connections and protocols (such as closed database protocols provided by software vendors) are often employed to effect data migration, requiring that the client as well as all other tenants be “locked-out” of the data as the data transfer progresses. Furthermore, such methods typically take place within a single thread, rather than leveraging the benefits of multi-threaded processing. In addition, existing technologies often require the efforts of specialized database administrators and network engineers to accomplish a database transfer. Furthermore, existing technologies often have difficulty in moving very large tenants reliably.

Accordingly, there is a need for improved systems and methods for migrating data between databases.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary multi-tenant data processing system;

FIG. 2 is a block diagram depicting the migration of data from one database to another database; and

FIG. 3 is a diagram that illustrates communication between a source and a target in accordance with an exemplary embodiment.

### DETAILED DESCRIPTION

The exemplary embodiments presented herein generally relate to systems and methods for migrating data between two or more multi-tenant databases using a Web protocol such as the hypertext transfer protocol (HTTP). In this way, secure, multi-threaded migration of data can be achieved with minimal administration and without using closed or hard-to-use database connection protocols.

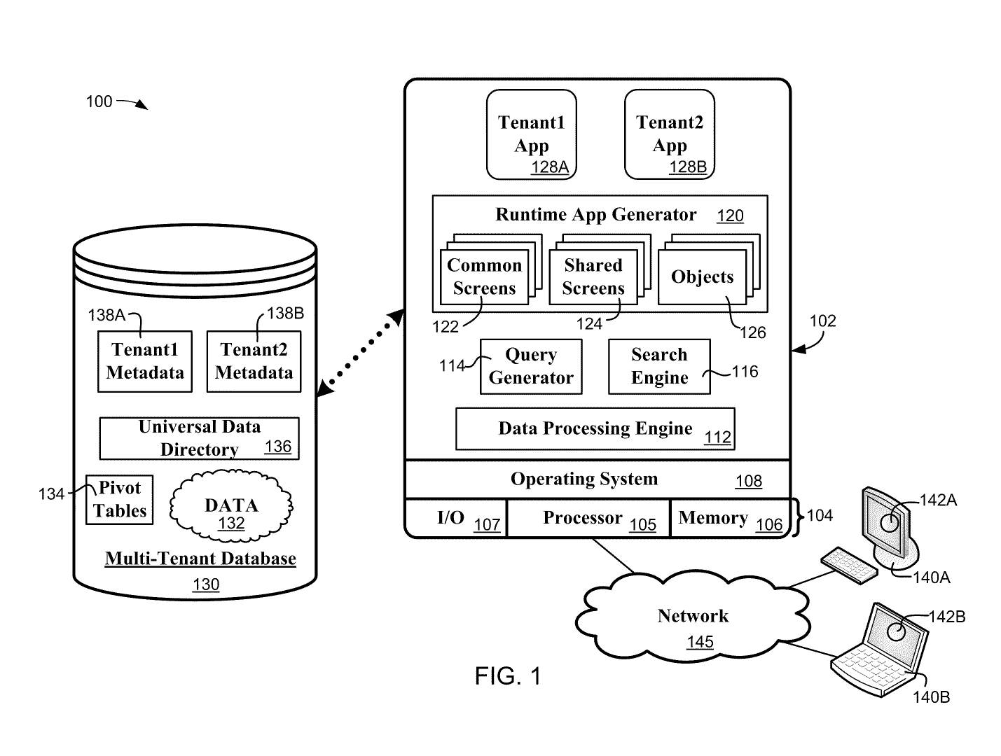

Turning now to FIG. 1, an exemplary multi-tenant application system 100 useful in describing various embodiments generally includes a server 102 that dynamically creates virtual applications 128 based upon data 132 from a common database 130 that is shared between multiple tenants. Data and services generated by the virtual applications 128 are provided via a network 145 to any number of client devices 140, as desired. Each virtual application 128 is suitably generated at run-time using a common application platform 110 that securely provides access to the data 132 in the database 130 for each of the various tenants subscribing to the system 100. In accordance with one non-limiting example, the system 100 may be implemented in the form of a multi-tenant CRM system that can support any number of authenticated users of multiple tenants.

A “tenant” generally refers to a group of users that shares access to common data within the database 130. Tenants may represent customers, customer departments, business or legal organizations, and/or any other entities that maintain data for particular sets of users within the system 100. Although multiple tenants may share access to the server 102 and the database 130, the particular data and services provided from the server 102 to each tenant can be securely isolated from those provided to other tenants. The multi-tenant architecture therefore allows different sets of users to share functionality without necessarily sharing any of the data 132.

The database 130 is any sort of repository or other data storage system capable of storing and managing the data 132 associated with any number of tenants. The database 130 may be implemented using any type of conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

The data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired.

Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants. Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 is implemented using one or more actual and/or virtual computing systems that collectively provide the dynamic application platform 110 for generating the virtual applications 128. The server 102 operates with any sort of conventional processing hardware 104, such as a processor 105, memory 106, input/output features 107 and the like. The processor 105 may be implemented using one or more of microprocessors, microcontrollers, processing cores and/or other computing resources spread across any number of distributed or integrated systems, including any number of “cloud-based” or other virtual systems. The memory 106 represents any non-transitory short or long term storage capable of storing programming instructions for execution on the processor 105, including any sort of random access memory (RAM), read only memory (ROM), flash memory, magnetic or optical mass storage, and/or the like. The input/output features 107 represent conventional interfaces to networks (e.g., to the network 145, or any other local area, wide area or other network), mass storage, display devices, data entry devices and/or the like. In a typical embodiment, the application platform 110 gains access to processing resources, communications interfaces and other features of the processing hardware 104 using any sort of conventional or proprietary operating system 108. As noted above, the server 102 may be implemented using a cluster of actual and/or virtual servers operating in conjunction with each other, typically in association with conventional network communications, cluster management, load balancing and other features as appropriate.

The application platform 110 is any sort of software application or other data processing engine that generates the virtual applications 128 that provide data and/or services to the client devices 140. The virtual applications 128 are typically generated at run-time in response to queries received from the client devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the client devices 140. The virtual applications 128 created by tenants are typically constructed in accordance with the tenant-specific metadata 138, which describes the particular tables, reports, interfaces and/or other features of the particular application. In various embodiments, each virtual application 128 generates dynamic web content that can be served to a browser or other client program 142 associated with its client device 140, as appropriate.

The runtime application generator 120 suitably interacts with the query generator 114 to efficiently obtain multi-tenant data 132 from the database 130 as needed. In a typical embodiment, the query generator 114 considers the identity of the user requesting a particular function, and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user that initiated the request.

The data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In operation, developers use the application platform 110 to create data-driven virtual applications 128 for the tenants that they support. Such virtual applications 128 may make use of interface features such as tenant-specific screens 124, universal screens 122 or the like. Any number of tenant-specific and/or universal objects 126 may also be available for integration into tenant-developed virtual applications 128. The data 132 associated with each virtual application 128 is provided to the database 130, as appropriate, and stored until it is requested or is otherwise needed, along with the metadata 138 that describes the particular features (e.g., reports, tables, functions, etc.) of that particular tenant-specific virtual application 128.

The data and services provided by the server 102 can be retrieved using any sort of personal computer, mobile telephone, tablet or other network-enabled client device 140 on the network 145. Typically, the user operates a conventional browser or other client program 142 to contact the server 102 via the network 145 using, for example, the hypertext transfer protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. The query generator 114 suitably obtains the requested data 132 from the database 130 as needed to populate the tables, reports or other features of the particular virtual application 128. In this regard, each tenant will typically be assigned or more associated “organization IDs” corresponding to a field in database 130, thereby identifying the data to which the user (and corresponding organizations) has access. As noted above, the virtual application 128 may contain Java, ActiveX, or other content and code that can be presented using conventional client software running on the client device 140; other embodiments may simply provide dynamic web or other content that can be presented and viewed by the user, as desired.

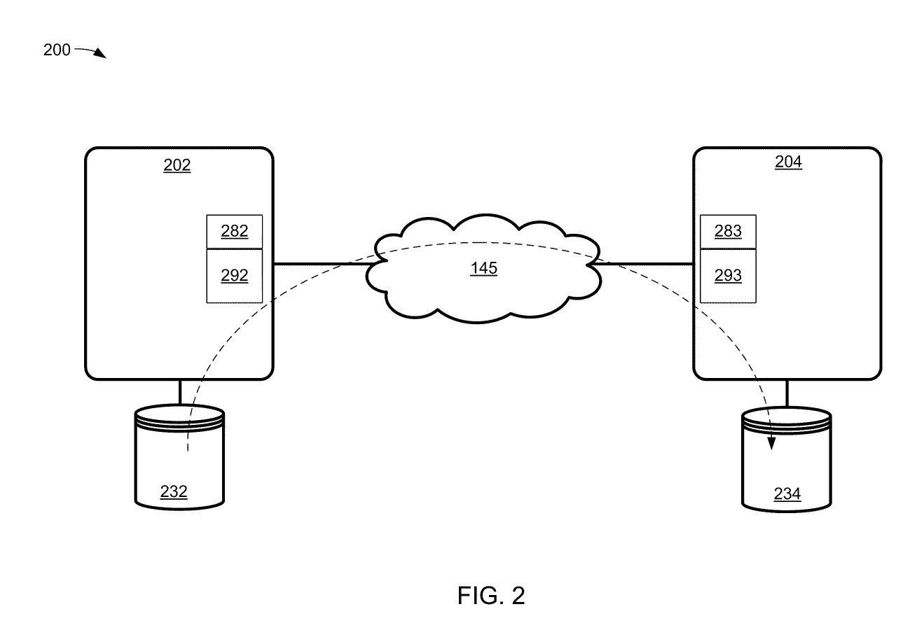

FIG. 2 is a conceptual block diagram useful in describing a Web-based database migration process in accordance with one embodiment. As shown, system 100 includes two databases, 232 and 234, which are suitably coupled to respective servers 202 and 204 and are communicatively coupled via network 145. Databases 232 and 234 may be referred to as separate “instances” of the same logical database (especially in the context of database migration). Servers 202 and 204, in the illustrated embodiment, are each implemented as a multi-tenant database server 102 as depicted in FIG. 1. Similarly, databases 232 and 234 are each implemented as a multi-tenant databases 130 as depicted in FIG. 1. In the interest of simplicity and clarity, various sub-components shown in FIG. 1 have not been included in FIG. 2.

For the purpose of illustration, it is assumed that data is to be migrated from database 232 to database 234 via server 202, network 145, and server 204 (illustrated, in general, by the dotted arrow shown in FIG. 2). Thus, server 202 and database 232 in this example may be collectively referred to as the “source,” and server 204 and database 234 may be collectively referred to as the “target.” Further, database 232 may be referred to as the “source database” (containing “source data”), and database 234 may be referred to as the “target database.”

Source server 202 includes a web service module 292 configured to interface with network 145 in accordance with a Web protocol as is known in the art. Similarly, target server 204 includes a web service module 293 configured to interface with network 145 in accordance with a Web protocol. Web services 292 and 293 may include any suitable set of software tools, software frameworks, and application programming interfaces (APIs) known in the art for enabling communication via a Web protocol such as HTTP.

In this regard, as used herein, the term “Web protocol” (or “Web-based protocol”) refers to one or more protocols and/or communication methods for providing data communication via the World Wide Web (also referred to as “the Web,” or “WWW”), for example, the hypertext transfer protocol (HTTP) promulgated by the Internet Engineering Task Force (IETF) and the World Wide Web Consortium (WWWC). See, for example, HTTP/1.1, defined in HTTP Working Group RFC 2616 (1999). In one embodiment, the Web protocol is a secure HTTP protocol (“HTTPS”). Other Web protocols include, without limitation, the Websocket protocol supported by HTML5 Web browsers.

Source server 202 includes an export module 282 communicatively coupled to web service 292. Export module 282 includes software configured to assist in the transfer of data from database 232 to database 234 over network 145 (via web service 292). In one embodiment, export module 282 includes a migration “servlet”—i.e., a small application (such as a Java applet) that runs on a server (such as server 202). Such servlets may be implemented using a variety of computer languages and application frameworks, including for example Java, Python, Ruby, or the like.

Target server 204 includes a client module 283 communicatively coupled to web service 293. Client module 283 includes software configured to assist in the transfer of data from database 232 to database 234 via network 145 (via web service 293). Note that module 283 is referred to as a “client” module in this example because target server 204 is effectively acting as a “client” with respect to server 202 (i.e., web service 292), as will be described in further detail below. This designation is not intended to be limiting, however; the client/server roles may be reversed in alternate embodiments. Note also that target server 204 may also include an export module (not illustrated), just as source server 202 may include a client module (not illustrated). Client module 283 may be a client servlet that runs on server 204 (e.g., on top of a Java virtual machine), an application that runs within a browser (such as an HTML5/Javascript/CSS application), or any other suitable application.

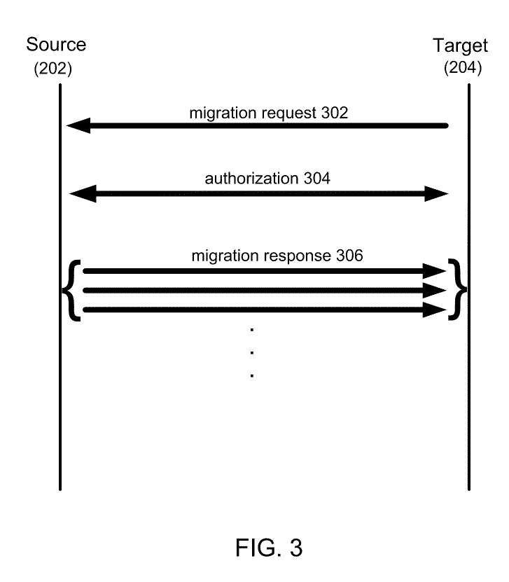

Having thus given an overview of a data migration system 200, an exemplary method for migrating data from target 204 to source 202 will now be described in conjunction with the diagram illustrated in FIG. 3, and following the example described above in conjunction with FIG. 2.

Initially, the target 204 sends a migration request to source 202 (step 302). This step begins the migration process. In one embodiment, the migration request includes a set of values (e.g., a stream of serializable Java objects) that together specify which data is to be migrated, how it is be transferred, and/or other information pertinent to the migration process.

For example, in one embodiment, the migration request includes one or more of (1) an organization ID, (2) a token, (3) a schema name, (4) a table name, (5) an action verb, and (6) one or more size indicators. Thus, without loss of generality, an example migration request using Java naming conventions (i.e., “camelcase”) might be of the form:

|orgID|token|schemaName|tableName|action|chunkSize|

In this example, the organization ID (“orgID”) value corresponds to the unique ID of the organization whose data is to be exported. As mentioned above, in a multi-tenant database, multiple organizations have access to the same logical and/or physical database. The orgID therefore limits the data transfer to records that are actually associated with a particular organization. In one embodiment, the organization ID is a 15-character serializable Java String object (java.lang.String).

The token (“token”) value is a special symbol that provides a form of authentication and/or an expiration date/time for the request. This token may be generated by a suitable administrator module as is known in the art. In one embodiment, the token is generated as a combination of an expiry date and a hash function (e.g., MD5) applied to the expiry date and a secret key. If the token is found to be invalid by source 202 (using the shared secret key), then the migration request will be ignored, and/or an exception will be thrown. In addition, it is desirable to determine that the requestor is on a local (i.e., authorized) network using, for example, IP address range restrictions.

The schema name (“schemaName”) value refers to the schema associated with the data to be migrated (e.g., CORE, SALES, MARKETING, etc.). As is known, a database schema is a collection of metadata that specifies the layout or blueprint of a particular subset of the database. Such metadata may be stored, for example, in metadata blocks 138A and 138B depicted in FIG. 1. In one embodiment, schemaName is a java.lang.String object.

The table name (“tableName”) value refers to the name of the table to be migrated (e.g., CUSTOM_ENTITY_DATA, ACCOUNT, etc.). In one embodiment, tableName is a java.lang.String object. As is known in the art, the “user” and the “schema” are typically the same—i.e., a table is owned by a schema/user. Two users may each have a table with the same name. In such a case, in order to differentiate tables it is desirable to specify a schema name. Schema name and table name are thus two keys required to address a given set of data (such as “accounts” or “contacts”).

The action verb (“action”) and size indicator together specify how the data is to be migrated. That is, the action verb and size indicator specify the size of each discrete block or “chunk” of data to be used during transfer and/or the upper and lower bounds of the data to be transferred.

In a particular embodiment, for example, the action verb has one of two values: “stones” or “data.” If the action verb is “stones,” then export module 282 serves “chunks” of data with breaks at every nth unique key value in the appropriate table (i.e., the table specified by tableName). This chunk size (n), in one embodiment, is a 32 bit integer value.

On the other hand, if the action verb is “data,” then export module serves one chunk of the table defined by a lower bound and an upper bound. In a particular embodiment, the lower bound (“lowerBound”) and upper bound (“upperBound”) are each an array of serializable java objects that specify the boundaries of the data to be served. An array of values may be necessary to express a particular key. After the migration request has been communicated from target 204 to source 202 (step 302), source 202 and target 204 undergo a suitable authorization process as is known in the art (step 304). During this process, the system checks that the request is from within an authorized network, and that the “token” is valid and not expired. Checking that the request originated in the authorized network is accomplished by checking the IP of the requestor and verifying that it is on the authorized network. The token is validated by taking the “row id” of the appropriate row, e.g., the “core.organization” row for the customer, concatenating it to a secret key and the expiry date (which is sent along with the token), then digesting it through MD5 and comparing the output with what was sent earlier from the client (source).

After successful authorization, source 202 begins sending data to target 204 via a migration response using a Web protocol (step 306). In one embodiment, transfer takes place using a standard HTTP “get” command known in the art. The data may be transferred as binary large objects (“BLOBs”) or character large objects (“CLOBs”) as are known in the art. The transfer of data takes place in accordance with the migration request received in step 302. That is, “chunks” of data with specified “breaks” or with specified bounds are transferred from source 202 to target 204, where the data is stored in database 234. Data transfer may take place as a single thread, or as multiple threads (e.g., 2 or more threads, as shown). In one embodiment, about two threads are used per table.

Certain common database components, such as a Java Database Connectivity (JDBC) API and related software, will typically be used to effect the ultimate storage of data within database 234; however, in the interest of clarity, such components have not been illustrated in FIG. 2. The transfer process will typically be accompanied by database “commits,” wherein the changes are “committed to” in each of the databases involved in the transfer. In one embodiment, commits are performed at regular intervals based on the time elapsed from the previous commit (e.g., about 40 minutes). Note that, in prior art systems, commits occur every kth row (for example, every ten-thousand rows), which can result in a greater database load and an overall reduction in database performance.

In a further embodiment, the user is not locked out from the schema or table in database 232 during the migration process. That is, database changes (“deltas”) are stored and used during the migration process when necessary. In one embodiment, multiple passes are made at the data, and only “deltas” are processed on the 2nd and subsequent passes. “Modification stamps” and delete logs are provided for all tables.

In another embodiment, the selection of which database records to migrate is made automatically in a way that is analogous to load balancing. That is, the export module 282 (or some other component) determines that a certain predefined criterion has been met (for example, unbalanced storage between servers), and subsequently causes the migration of data to take place automatically, without user interaction.

In another embodiment, the techniques described above could be used to create “sandboxed” versions of the data, that is, databases that are copies (or back-ups) of the original databases rather than actual migrated databases.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Thus, although several exemplary embodiments have been presented in the foregoing description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a tangible processor-readable medium, which may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, or the like.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-implemented method for database migration, the method comprising:
identifying a first multi-tenant database, the first multi-tenant database having a plurality of data records stored therein;
identifying a second multi-tenant database; and
transferring the plurality of data records from the first multi-tenant database to the second multi-tenant database over a network using a Web protocol.

2. The method of claim 1, wherein the transferring comprises transferring the plurality of data records using a hypertext transfer protocol (HTTP).

3. The method of claim 1, wherein the transferring includes transferring the plurality of data records as serializable Java objects.

4. The method of claim 1, further including:
receiving, at the first multi-tenant database, a migration request; and
initiating the transferring of the plurality of data records in response to the migration request.

5. The method of claim 4, wherein the migration request includes:
an organization ID identifying an organization associated with the plurality of data records.

6. The method of claim 5, wherein:
the transferring includes sending a plurality of discrete blocks of the data records; and
the migration request further includes a size indicator specifying the size of the discrete blocks.

7. The method of claim 6, wherein the migration request further includes a schema ID and a table ID.

8. A computer-implemented method for migrating data from a first multi-tenant database server to a second multi-tenant database server over a network, comprising:
receiving, at the first multi-tenant database server, a migration request including an organization ID associated with a subset of the data and;
sending, in response to the migration request, a set of data records to the second multi-tenant database server via a hypertext transfer protocol (HTTP), wherein the set of data records are associated with the organization ID.

9. The method of claim 8, wherein sending the set of data records includes sending the data records as serializable Java objects.

10. The method of claim 8, wherein sending the set of data records includes sending a plurality of discrete blocks of the data records; and
the migration request further includes a size indicator specifying the size of the discrete blocks.

11. A database system comprising:
a first multi-tenant database system including a plurality of data records; and
a second multi-tenant database system communicatively coupled to the first multi-tenant database over a network;
wherein the first multi-tenant database system includes an export module configured to send the plurality of data records to the second multi-tenant database server over the network via a Web protocol.

12. The database system of claim 11, wherein the second multi-tenant database system includes a client module configured to send a migration request to the export module, and wherein the export module is configured to send the plurality of records in response to the migration request.

13. The database system of claim 12, wherein the plurality of data records are sent as a plurality of discrete blocks, and the migration request includes:
an organization ID identifying an organization associated with the plurality of data records; and
a size indicator specifying the size of the discrete blocks.

14. The database system of claim 13, wherein the migration request further includes a token indicative of an expiration date for the migration request.

15. The database system of claim 12, wherein the Web protocol is a secure hypertext transfer protocol (HTTPS).

16. The database system of claim 12, therein the plurality of data records are sent as serializable Java objects.

17. The database system of claim 12, wherein the plurality of data records are sent using multiple threads.

18. The database system of claim 12, wherein the migration request further includes a table indicator associated with a table defined for the plurality of data records.

19. The database system of claim 12, wherein the migration request further includes a schema indicator associated with a schema defined for the plurality of data records.

20. The database of claim 12, wherein the export module comprises a servlet running on the first multi-tenant database system, and the client module comprises a servlet running on the second multi-tenant database system.
